(19) United States
(12) Patent Application Publication
(10) Pub. No.: US 2025/0037142 A1
(43) Pub. Date: Jan. 30, 2025

(54) CARBON-AWARE WORKLOAD ALLOCATION IN CLOUD ENVIRONMENT

(71) Applicant: INTERNATIONAL BUSINESS MACHINES CORPORATION, Armonk, NY (US)

(72) Inventors: Sudip Dutta, Kolkata (IN); Charbak Roy, Kolkata (IN); Diptiman Dasgupta, Kolkata (IN); Jignesh Karia, Thane (IN)

(21) Appl. No.: 18/361,496

(22) Filed: Jul. 28, 2023

(51) Int. Cl. G06Q 30/018; G06F 9/50

(52) U.S. Cl. CPC G06Q 30/018; G06F 9/5083

(57) ABSTRACT

A workload allocation engine is configured to allocate a workload in a cloud architecture. A data center for an enterprise is identified, and for the data center, a plurality of servers within the data center and a plurality of virtual machines (VMs) running on the servers are identified. Based upon at least one predetermined factor, a plurality of clusters of the servers generated. For each of the clusters, a plurality of time-series variables are tracked. For each of the clusters and the workload, carbon emissions generated by a particular cluster and for the workload are predicted. The workload is assigned to the particular cluster based upon the predicted carbon emissions associated with the particular cluster, and the workload is performed by the particular cluster.

### BACKGROUND

The present invention relates to hybrid cloud environments, and more specifically, to carbon-aware allocation of workloads to a hybrid cloud environment.

Investors are increasingly scrutinizing environmental, social and governance (ESG) performance—and looking for companies/enterprises to rise to the challenge of delivering ESG improvements. Consequently, enterprises are looking to provide sustainability leadership by setting organization-wide sustainability goals. Many different types of standards are being employed to achieve sustainability goals and include Global Reporting Initiative (GRI), Task Force on Climate-related Financial Disclosures (TCFD), Sustainability Accounting Standards Board (SASB), European Public Real Estate (EPRA), and Greenhouse Gas (GHG) Protocol for data centers among others.

Worldwide, energy consumption from data centers was projected to increase from 2-3% in 2010 to around 8-10% by 2030. However, the recent shift to remote work has increased that projection to 15% by 2030. Consequently, to fulfill government regulations and compliance measures, organizations/enterprises are looking to reevaluate their IT operations in order to reduce carbon emissions from day-to-day operations.

Currently, workloads in a cloud or hybrid-cloud environment are allocated based on a cost based optimization model or a resource utilization-based optimization model. However, neither of the optimization models consider carbon emission as a factor for optimizing workload allocation. With meeting ESG performance measures being an important goal for many enterprises, there is a need to allocate workloads in a manner the aids this ESG goal.

### SUMMARY

A method performed by workload allocation engine for allocating a workload in a cloud architecture. A data center for an enterprise is identified, and for the data center, a plurality of servers within the data center and a plurality of virtual machines (VMs) running on the servers are identified. Based upon at least one predetermined factor, a plurality of clusters of the servers generated. For each of the clusters, a plurality of time-series variables are tracked. For each of the clusters and the workload, carbon emissions generated by a particular cluster and for the workload are predicted. The workload is assigned to the particular cluster based upon the predicted carbon emissions associated with the particular cluster, and the workload is performed by the particular cluster.

Additionally, the enterprise includes a plurality of data centers. The at least one predetermined factor is selected from a group consisting of: architecture similarity, load profile similarity, and CPU architecture. The carbon emissions is predicted using a statistical method, and the statistical method predicts a breakpoint in which a ratio of energy consumption to computation load becomes non-linear. The workload is assigned to the particular cluster based upon an affinity the workload has to a previously-assigned workload, and the affinity is based upon a relationship between the workload and the previously-assigned workload that impacts an amount of carbon emissions generated by a combination of the workload and the previously-assigned workload.

A workload allocation engine is configured to allocate a workload in a cloud architecture. A data center for an enterprise is identified, and for the data center, a plurality of servers within the data center and a plurality of virtual machines (VMs) running on the servers are identified. Based upon at least one predetermined factor, a plurality of clusters of the servers generated. For each of the clusters, a plurality of time-series variables are tracked. For each of the clusters and the workload, carbon emissions generated by a particular cluster and for the workload are predicted. The workload is assigned to the particular cluster based upon the predicted carbon emissions associated with the particular cluster, and the workload is performed by the particular cluster.

Additionally, the enterprise includes a plurality of data centers. The at least one predetermined factor is selected from a group consisting of: architecture similarity, load profile similarity, and CPU architecture. The carbon emissions is predicted using a statistical method, and the statistical method predicts a breakpoint in which a ratio of energy consumption to computation load becomes non-linear. The workload is assigned to the particular cluster based upon an affinity the workload has to a previously-assigned workload, and the affinity is based upon a relationship between the workload and the previously-assigned workload that impacts an amount of carbon emissions generated by a combination of the workload and the previously-assigned workload.

A computer program product comprises a computer readable storage medium having stored therein program code. The program code, which when executed by a workload allocation engine, causes the workload allocation engine to perform the following. A data center for an enterprise is identified, and for the data center, a plurality of servers within the data center and a plurality of virtual machines (VMs) running on the servers are identified. Based upon at least one predetermined factor, a plurality of clusters of the servers generated. For each of the clusters, a plurality of time-series variables are tracked. For each of the clusters and the workload, carbon emissions generated by a particular cluster and for the workload are predicted. The workload is assigned to the particular cluster based upon the predicted carbon emissions associated with the particular cluster, and the workload is performed by the particular cluster.

Additionally, the enterprise includes a plurality of data centers. The at least one predetermined factor is selected from a group consisting of: architecture similarity, load profile similarity, and CPU architecture. The carbon emissions is predicted using a statistical method, and the statistical method predicts a breakpoint in which a ratio of energy consumption to computation load becomes non-linear. The workload is assigned to the particular cluster based upon an affinity the workload has to a previously-assigned workload, and the affinity is based upon a relationship between the workload and the previously-assigned workload that impacts an amount of carbon emissions generated by a combination of the workload and the previously-assigned workload.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 is a block diagram illustrating an example architecture of a data center and workload allocation engine according to an embodiment of the present invention.

FIG. 2 is a block diagram further illustrating the workload allocation engine of FIG. 1 according to an embodiment of the present invention.

FIGS. 3A and 3B are examples of a methodology employing the workload allocation engine of FIG. 2 according to an embodiment of the present invention.

FIG. 4 is a block diagram illustrating an example of computer environment for implementing portions of the methodology of FIGS. 3A and 3B.

### DETAILED DESCRIPTION

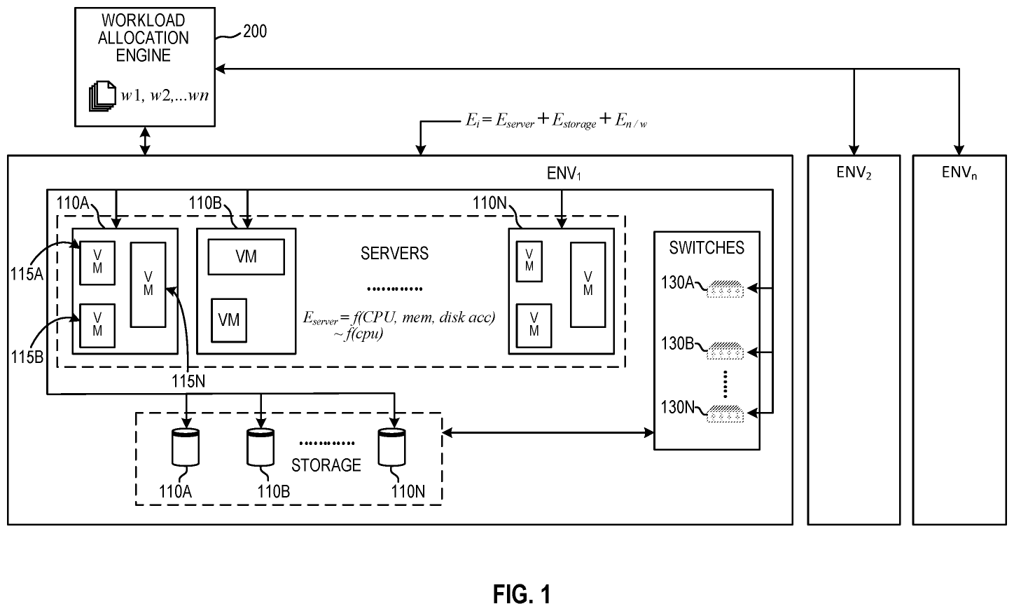

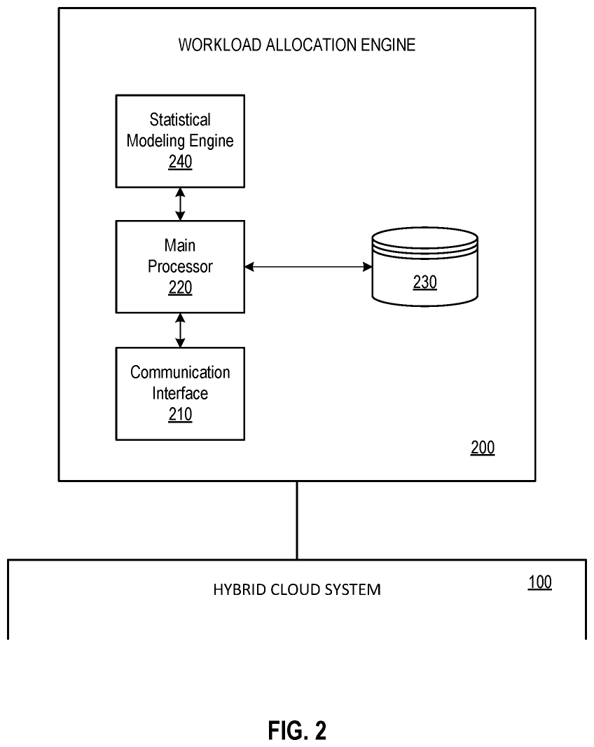

FIGS. 1 and 2 respectively illustrate an exemplary data center environments (e.g., data center 100) ENV₁, ENV₂, . . . . ENVₙ and associated workload allocation engine 200. The present disclosure addresses the problem of minimizing carbon emissions C_{wi} for a set of workloads (w1, w2, . . . wn) that are to be allocated across the servers 110A-N and virtual machines 115A-N of the various data center environments ENV₁, ENV₂, . . . . ENVₙ (i.e., minΣ_{w1}^{wn}C_{wi}).

Although discussed in more detail below, the workload allocation engine 200 is configured to allocate the workloads w1, w2, . . . wn in a hybrid cloud architecture comprising the data center environments (e.g., data center 100) ENV₁, ENV₂, . . . . ENVₙ. As is commonly known, a hybrid cloud architecture includes one or more hyper-scalers (e.g., . . . , large public cloud service providers) and one or more private data center environments ENV₁, ENV₂, . . . . ENVₙ. Although the present disclosure refers to allocating the workloads w1, w2, . . . wn to the private data center environments ENV₁, ENV₂, . . . . ENVₙ, the disclosure is not limited in this manner. In certain instances, the hyper-scalers allocate specific hardware to a particular enterprise. In this instance, the specific hardware can be evaluated in the same manner as one of the private data center environments ENV₁, ENV₂, . . . . ENVₙ.

The inventive embodiments include identifying a data center 100 for an enterprise, a plurality of servers 110A-N within the data center 100, and a plurality of virtual machines (VMs) 115A-N running on the servers 110A-N are identified. This can also be performed within each data center environments ENV₁, ENV₂, . . . . ENVₙ, of the hybrid cloud architecture. Based upon at least one predetermined factor, a plurality of clusters of the servers 110A-N generated. For each of the clusters, a plurality of time-series variables are tracked. For each of the clusters and the workload, carbon emissions generated by a particular cluster and for the workload are predicted. The workload is assigned to the particular cluster based upon the predicted carbon emissions associated with the particular cluster, and the workload is performed by the particular cluster.

According to the GHG protocol, all emissions (e.g., carbon) of a data center 100 must be allocated to individual services. As used herein, a “service” (or “user service”) is defined as an executable product (e.g., a computer program) that requires computing resources such as processing and storage and is associated with a particular user. These emissions are oftentimes divided into different scopes (e.g., Scope 1, Scope 2, and Scope 3). Scope 1 captures emissions that are directly generated by an enterprise and its controlled entities. Scope 2 captures emission that are indirectly generated as a result of activities by an enterprise (e.g., the emissions used from the generation of purchased energy used by the enterprise). Scope 3 captures indirectly-generated emissions that are not included in Scope 2, and these include both upstream and downstream emissions. These emissions can include emissions generated as a result of employee travel and commuting, distribution of raw materials from suppliers, distribution of finished products to consumers, use of finished products, and end-of-life handling of products.

Typically, the power consumed in the data center 100 is from the servers 100A-N, storage 120A-N, and network devices 130A-N (e.g., top of rack (TOP) and aggregation (AGG) switches). The carbon efficiency for a particular data center 100 can be characterized using two factors: Power Usage Effectiveness (PUE) and Carbon Intensity (CI). Thus, the carbon footprint, C(t) for a particular data center 100 with energy consumption, E, over time t can be calculated as: C(t)=E(t)×PUE(t)×CI(t), where the energy consumed by the data center Eᵢ is be determined using an energy consumption model. Although not limited in this manner, the energy consumption model could be Eᵢ=Eₛₑᵣᵥₑᵣ+E_{storage}+E_{n/w} (i.e., server, storage, and networking). Additionally, while the Eₛₑᵣᵥₑᵣ is typically a function of CPU, memory, and disk assess usage (i.e., f (CPU, mem disk, disk acc)), Eₛₑᵣᵥₑᵣ can be approximated as a function of just CPU (i.e., f (CPU)).

As part of the protocol discussed above, all IT devices (e.g., servers 110A-N, storage 120A-N, and switches 130A-N) and the power consumed therefrom should be allocated to a particular service. Although not limited in this manner, the manner by which the consumed power is allocated/distributed to workloads should be compliant with the GHG protocol. If a particular IT device supports more than a single service, then the emissions associated with that device should be allocated over the multiple services. Moreover, if an IT device is used to manage workloads for a particular service, then the managing IT device should be allocated to the particular service. Additionally, if an IT device acts as reserve capacity for a particular service, then that reserve IT device should be allocated to the particular service. Ultimately, every IT device within the data center 100 is fully allocated, either directly or indirectly, to a user service.

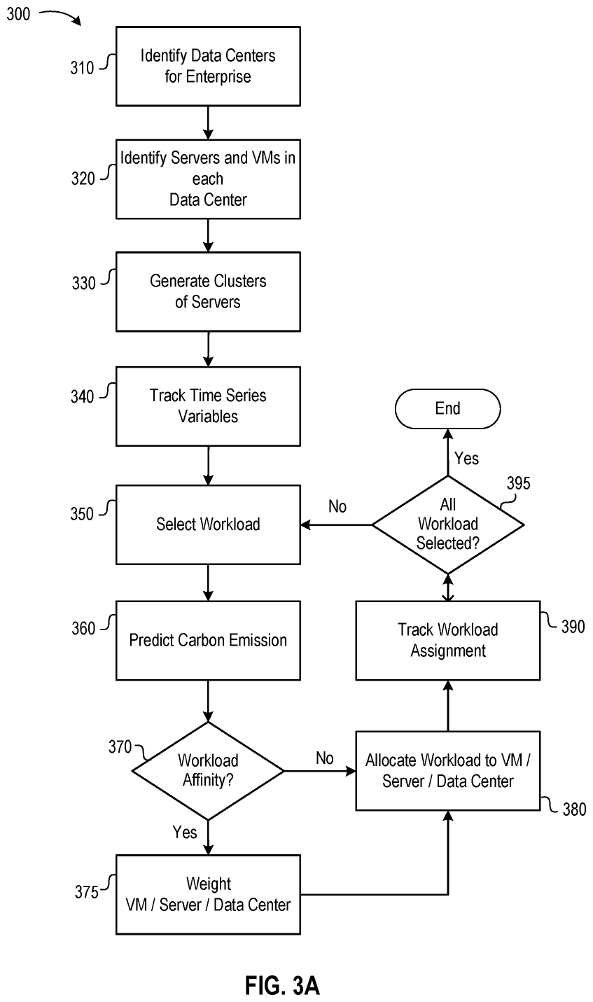

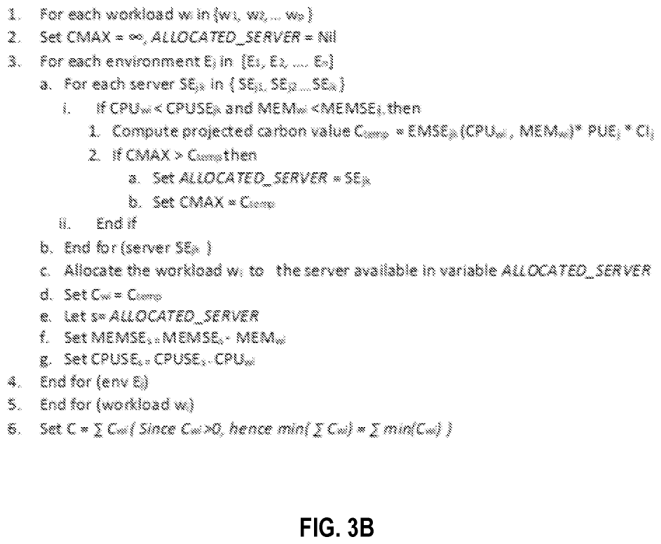

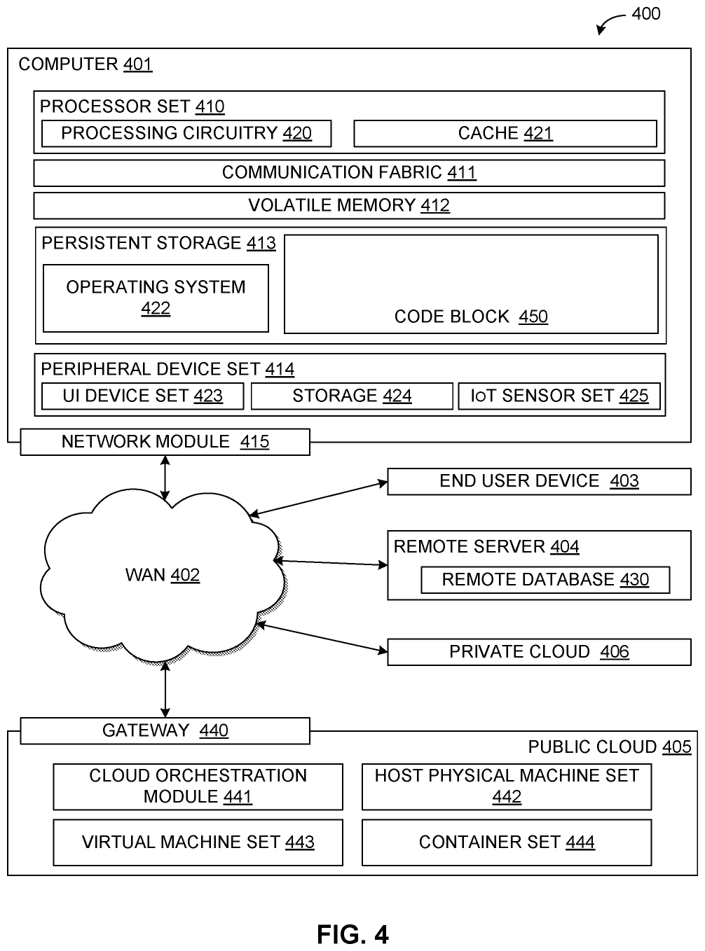

With reference to FIGS. 3A and 3B, an overview of the general process 300 for employing the workload allocation engine 200 is disclosed. FIG. 4 illustrates pseudo code for performing at least certain operations of the process 300. In 310, one or more data centers 100 (e.g., ENV₁, ENV₂, . . . . ENVₙ) associated with an enterprise are identified. These data centers 100 can be remote (e.g., as part of a hybrid-cloud service) and/or local. In 320, once the one or more data centers 100 are identified, a plurality of servers 110A-N and virtual machines 115A-N running in each of the servers 110A-N are also identified. The ability to identify servers 110A-N and virtual machines 115A-N in a data center 100 is known, and the process 300 is not limited to any particular approach so capable.

In 330, a plurality of clusters of servers 110A-N are generated by the workload allocation system 200 based upon one or more pre-defined factors. Server clusters are sets of servers 110A-N that can be managed together and facilitate workload management. Server clusters also enable enterprise applications to scale beyond the amount of throughput capable of being achieved with a single application server 110A-N. Moreover, server clusters enable enterprise applications to be highly available because requests are automatically routed to the running servers 110A-N in the event of a failure. Despite being in the same server cluster, the servers 110A-N that are members of a server cluster can be on different host machines. Although not limited in this manner, the one or more pre-defined factors can include: architecture similarity (e.g., similar size), load profile similarity (e.g., the size of the workload a particular server 110A-N is capable of handling), and central processing unit (CPU) architecture.

In 340, each of the server clusters is tracked. Specifically, for each server clusters, one or more time-series variables are tracked. Although not limited in this manner, the variables include: power consumed P (t) and/or energy consumer E (t), cumulative size of all VMs 115A-N on a particular server 110A-N within the server cluster, cumulative utilization of all VMs 115A-N on a particular server 110A-N within the server cluster, cumulative time in which all VMs 115A-N on a particular server 110A-N within the server cluster are active, and cumulative utilization of all servers 110A-N within the server cluster. Additionally, the probability that a particular VM 115A-N will be assigned to a particular server 110A-N within the server cluster can also be tracked.

In 350, a workload from the plurality of workloads w1, w2, . . . wn to be assigned is selected. In 360, carbon emissions/carbon footprint (C) is predicted for at least one VM/server cluster/data center combinations, and in certain aspects, the carbon footprint (C) is predicted for all possible server clusters capable of performing the particular workload. As discussed above, the carbon footprint, C(t), can be calculated as: C(t)=E(t)×PUE(t)×CI(t), where PUE is Power Usage Effectiveness of the server cluster, E is energy consumption of the server cluster, and CI is Carbon Intensity of the server cluster. In FIG. 4, power consumed by a particular server is as EMSEᵢⱼ, the power consumed by a particular memory is MEMSEᵢⱼ, and the power consumed by a particular CPU is CPUSEᵢⱼ.

Although not limited in this manner, carbon emissions could be predicted using a statistical modeling engine 240 (e.g., a statistical method) that has been trained using historical data of carbon emissions to determine PUE(t), CI(t), and E(t). The statistical modeling engine 240 can perform the prediction using one or more of the following factors: the particular workload, the particular server cluster, and the previously-tracked variables from 345. The statistical modeling engine 240 can also be configured to identify breakpoints in which the ratio of energy consumption to computation load becomes non-linear. These breakpoints signal instances in which a switch to a different server cluster can be more efficient since the prior server cluster is becoming less efficient as the workload (and hence energy consumptions) increases.

In 370, an optional determination can be made as to whether the selected workload wi has an affinity to a previously-assigned workload. As used herein, an “affinity” refers to a relationship between two workloads in which the physical and/or logical distance between these two workloads impacts the amount of carbon emissions generated by the combination of the workloads and/or the performance of these workloads. For example, if an e-commerce application requires two workloads to be performed (e.g., one workload running a front-end client interface and another workload running an inventory tracker), these two workloads will very likely be exchanging significant amounts of data between one another. In this instance, having the VMs performing these workloads be located in two different physical locations could increase the number of data transfers needed to exchange the data between the VMs, which can negatively impact both performance (e.g., in terms of latency) and the amount of carbon emissions (e.g., because the additional data transfers will consume additional energy).

In an affinity exists between the selected workload wi and a previously-assigned workload, then the process proceeds to operation 375. Otherwise, the operation proceeds to 380. In 375, based upon an determined affinity between the selected workload wi and a previously-assigned workload, the VM/server cluster/data center combination to which the previously-assigned workload is operating within will be given a higher weight, which will increase the probability that the VM/server cluster/data center combination will be chosen to host the selected workload wᵢ. The manner by which the weighting is accomplished is not limited as to a particular approach. For example, if reduction in carbon emissions and/or the gain in performance is minimal, a less-impactful weight can be assigned.

In 380, based upon the carbon emissions C_{wi} predicted for the selected workload wᵢ, as modified by the weight from operation 375, a particular server cluster, as a low-carbon environment, is selected to perform the selected workload wi. While other factors can be employed in selecting the server cluster, as is currently known, the present disclosure contemplates an additional factor in selecting the one or more particular server clusters—the amount of carbon emissions C_{wi} that have been predicted to be associated with the performance of the workload wi by the selected server cluster. Also, as discussed above, the prediction of carbon emissions in 360 can identify breakpoints where the ratio of energy consumption to computation load becomes non-linear. Consequently, as more efficient server clusters become less efficient, the workload allocation engine 200 can dynamically select different clusters of servers 110A-N to perform the selected workload wᵢ.

In 390, virtual machine/server cluster/data server assignment for each workload is tracked. This can be subsequently used, in operation 370, to determine whether an affinity exists between the just assigned workload wi and a workload to be subsequently assigned. This operations of 350-390 are performed for each of the workloads w1, w2, . . . wn until a determination, in 395, that no additional workloads are to be evaluated.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

Referring to FIG. 4, computing environment 400 contains an example of an environment for the execution of at least some of the computer code involved in performing the inventive methods, such as code block 450 for implementing the operations of the ESG management platform 100, ESG managing server 110, and client devices 120A-C. Computing environment 400 includes, for example, computer 401, wide area network (WAN) 402, end user device (EUD) 403, remote server 404, public cloud 405, and private cloud 406. In certain aspects, computer 401 includes processor set 410 (including processing circuitry 420 and cache 421), communication fabric 411, volatile memory 412, persistent storage 413 (including operating system 422 and method code block 450), peripheral device set 414 (including user interface (UI), device set 423, storage 424, and Internet of Things (IOT) sensor set 425), and network module 415. Remote server 404 includes remote database 430. Public cloud 405 includes gateway 440, cloud orchestration module 441, host physical machine set 442, virtual machine set 443, and container set 444.

Computer 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. However, to simplify this presentation of computing environment 400, detailed discussion is focused on a single computer, specifically computer 401. Computer 401 may or may not be located in a cloud, even though it is not shown in a cloud in FIG. 4 except to any extent as may be affirmatively indicated.

Processor set 410 includes one, or more, computer processors of any type now known or to be developed in the future. As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In certain computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods discussed above in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in code block 450 in persistent storage 413.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible, hardware device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Communication fabric 411 is the signal conduction paths that allow the various components of computer 401 to communicate with each other. Typically, this communication fabric 411 is made of switches and electrically conductive paths, such as the switches and electrically conductive paths that make up busses, bridges, physical input/output ports and the like. Other types of signal communication paths may be used for the communication fabric 411, such as fiber optic communication paths and/or wireless communication paths.

Volatile memory 412 is any type of volatile memory now known or to be developed in the future. Examples include dynamic type random access memory (RAM) or static type RAM. Typically, the volatile memory 412 is characterized by random access, but this is not required unless affirmatively indicated. In computer 401, the volatile memory 412 is located in a single package and is internal to computer 401. In addition to alternatively, the volatile memory 412 may be distributed over multiple packages and/or located externally with respect to computer 401.

Persistent storage 413 is any form of non-volatile storage for computers that is now known or to be developed in the future. The non-volatility of the persistent storage 413 means that the stored data is maintained regardless of whether power is being supplied to computer 401 and/or directly to persistent storage 413. Persistent storage 413 may be a read only memory (ROM), but typically at least a portion of the persistent storage 413 allows writing of data, deletion of data and re-writing of data. Some familiar forms of persistent storage 413 include magnetic disks and solid state storage devices. Operating system 422 may take several forms, such as various known proprietary operating systems or open source Portable Operating System Interface type operating systems that employ a kernel. The code included in code block 450 typically includes at least some of the computer code involved in performing the inventive methods.

Peripheral device set 414 includes the set of peripheral devices for computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet.

In various aspects, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some aspects, storage 424 may take the form of a quantum computing storage device for storing data in the form of qubits. In aspects where computer 401 is required to have a large amount of storage (for example, where computer 401 locally stores and manages a large database) then this storage 424 may be provided by peripheral storage devices designed for storing very large amounts of data, such as a storage area network (SAN) that is shared by multiple, geographically distributed computers. Internet-of-Things (IOT) sensor set 425 is made up of sensors that can be used in IoT applications. For example, one sensor may be a thermometer and another sensor may be a motion detector.

Network module 415 is the collection of computer software, hardware, and firmware that allows computer 401 to communicate with other computers through a Wide Area Network (WAN) 402. Network module 415 may include hardware, such as modems or Wi-Fi signal transceivers, software for packetizing and/or de-packetizing data for communication network transmission, and/or web browser software for communicating data over the internet. In certain aspects, network control functions and network forwarding functions of network module 415 are performed on the same physical hardware device. In other aspects (for example, aspects that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415.

WAN 402 is any Wide Area Network (for example, the internet) capable of communicating computer data over non-local distances by any technology for communicating computer data, now known or to be developed in the future. In some aspects, the WAN 402 ay be replaced and/or supplemented by local area networks (LANs) designed to communicate data between devices located in a local area, such as a Wi-Fi network. The WAN 402 and/or LANs typically include computer hardware such as copper transmission cables, optical transmission fibers, wireless transmission, routers, firewalls, switches, gateway computers and edge servers.

End user device (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In certain aspects, EUD 403 may be a client device, such as thin client, heavy client, mainframe computer, desktop computer and so on.

As defined herein, the term “client device” means a data processing system that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein. As defined herein, the term “user” means a person (i.e., a human being).

Remote server 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404. As defined herein, the term “server” means a data processing system configured to share services with one or more other data processing systems.

Public cloud 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402.

VCEs can be stored as “images,” and a new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container. a feature which is known as containerization.

Private cloud 406 is similar to public cloud 405, except that the computing resources are only available for use by a single enterprise. While private cloud 406 is depicted as being in communication with WAN 402, in other aspects, a private cloud 406 may be disconnected from the internet entirely (e.g., WAN 402) and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this aspect, public cloud 405 and private cloud 406 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

As another example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. Each block in the flowchart or block diagrams may represent a module, segment, or portion of instructions, which comprises one or more executable instructions for implementing the specified logical function(s).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes.” “including.” “comprises,” and/or “comprising.” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” “one arrangement,” “an arrangement,” “one aspect,” “an aspect,” or similar language means that a particular feature, structure, or characteristic described in connection with the embodiment is included in at least one embodiment described within this disclosure. Thus, appearances of the phrases “one embodiment.” “an embodiment.” “one arrangement.” “an arrangement.” “one aspect,” “an aspect.” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting.” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “if.” “when,” “upon,” “in response to,” and the like are not to be construed as indicating a particular operation is optional. Rather, use of these terms indicate that a particular operation is conditional. For example and by way of a hypothetical, the language of “performing operation A upon B” does not indicate that operation A is optional. Rather, this language indicates that operation A is conditioned upon B occurring.

The foregoing description is just an example of embodiments of the invention, and variations and substitutions. While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

What is claimed is:

1. A method, with a workload allocation engine, of allocating a workload in a cloud architecture, comprising:
identifying, for an enterprise, a data center, a plurality of servers within the data center, and a plurality of virtual machines (VMs) running on the plurality of servers;
generating, based upon at least one predetermined factor, a plurality of clusters of the servers;
tracking, for each of the clusters, a plurality of time-series variables;
predicting, for each of the clusters and the workload, carbon emissions generated by a particular cluster and for the workload; and
assigning the workload to the particular cluster based upon the predicted carbon emissions associated with the particular cluster, wherein the workload is performed by the particular cluster.

2. The method of claim 1, wherein
the enterprise includes a plurality of data centers.

3. The method of claim 1, wherein
the at least one predetermined factor is selected from a group consisting of:
architecture similarity,
load profile similarity, and
CPU architecture.

4. The method of claim 1, wherein
the carbon emissions is predicted using a statistical method.

5. The method of claim 4, wherein
the statistical method predicts a breakpoint in which a ratio of energy consumption to computation load becomes non-linear.

6. The method of claim 1, wherein
the workload is assigned to the particular cluster based upon an affinity the workload has to a previously-assigned workload.

7. The method of claim 6, wherein
the affinity is based upon a relationship between the workload and the previously-assigned workload that impacts an amount of carbon emissions generated by a combination of the workload and the previously-assigned workload.

8. A computer hardware system including a workload allocation engine for allocating a workload in a cloud architecture, comprising:
a hardware processor configured to initiate the following executable operations:
identifying, for an enterprise, a data center, a plurality of servers within the data center, and a plurality of virtual machines (VMs) running on the plurality of servers;
generating, based upon at least one predetermined factor, a plurality of clusters of the servers;
tracking, for each of the clusters, a plurality of time-series variables;
predicting, for each of the clusters and the workload, carbon emissions generated by a particular cluster and for the workload; and
assigning the workload to the particular cluster based upon the predicted carbon emissions associated with the particular cluster, wherein
the workload is performed by the particular cluster.

9. The system of claim 8, wherein
the enterprise includes a plurality of data centers.

10. The system of claim 8, wherein
the at least one predetermined factor is selected from a group consisting of:
architecture similarity,
load profile similarity, and
CPU architecture.

11. The system of claim 8, wherein
the carbon emissions is predicted using a statistical method.

12. The system of claim 11, wherein
the statistical method predicts a breakpoint in which a ratio of energy consumption to computation load becomes non-linear.

13. The system of claim 8, further comprising
the workload is assigned to the particular cluster based upon an affinity the workload has to a previously-assigned workload.

14. The system of claim 13, wherein
the affinity is based upon a relationship between the workload and the previously-assigned workload that impacts an amount of carbon emissions generated by a combination of the workload and the previously-assigned workload.

15. A computer program product, comprising:
a computer readable storage medium having stored therein program code for allocating a workload in a cloud architecture,
the program code, which when executed by a workload allocation engine, causes the workload allocation engine to perform:
identifying, for an enterprise, a data center, a plurality of servers within the data center, and a plurality of virtual machines (VMs) running on the plurality of servers;
generating, based upon at least one predetermined factor, a plurality of clusters of the servers;
tracking, for each of the clusters, a plurality of time-series variables;
predicting, for each of the clusters and the workload, carbon emissions generated by a particular cluster and for the workload; and
assigning the workload to the particular cluster based upon the predicted carbon emissions associated with the particular cluster, wherein
the workload is performed by the particular cluster.

16. The computer program product of claim 15, wherein
the enterprise includes a plurality of data centers.

17. The computer program product of claim 15, wherein
the at least one predetermined factor is selected from a group consisting of:
architecture similarity,
load profile similarity, and
CPU architecture.

18. The computer program product of claim 15, wherein
the carbon emissions is predicted using a statistical method.

19. The computer program product of claim 18, wherein
the statistical method predicts a breakpoint in which a ratio of energy consumption to computation load becomes non-linear.

20. The computer program product of claim 15, wherein
the workload is assigned to the particular cluster based upon an affinity the workload has to a previously-assigned workload, and
the affinity is based upon a relationship between the workload and the previously-assigned workload that impacts an amount of carbon emissions generated by a combination of the workload and the previously-assigned workload.
